(19) United States
(12) Patent Application Publication
(10) Pub. No.: US 2020/0031021 A1
(43) Pub. Date: Jan. 30, 2020

(54) METHOD FOR PRODUCING FIBER TAPE

(71) Applicant: SABIC GLOBAL TECHNOLOGIES B.V., BERGEN OP ZOOM (NL)

(72) Inventors: Reema Sinha, Benagaluru (IN); Anton Kumanan, Benagaluru (IN); Nikhil Verghese, Geleen (NL); Theofanis Theofanous, Sugar Land, TX (US); Kapil Inamdar, Exton, PA (US)

(21) Appl. No.: 16/484,236

(22) PCT Filed: Feb. 12, 2018
(86) PCT No.: PCT/IB2018/050856

§ 371 Date: Aug. 7, 2019

Related U.S. Application Data
(60) Provisional application No. 62/458,287, filed on Feb. 13, 2017.

(51) Int. Cl. B29B 15/12

(52) U.S. Cl. CPC B29B 15/125; B29K 2069/00

(57) ABSTRACT

Method for producing a fiber tape including spreading a strand of fibers into a spreaded fiber layer, immersing the spreaded fiber layer in a solution, and forming a fiber tape from the spreaded fiber layer by applying heat and/or pressure to the spreaded fiber layer.

### CROSS-REFERENCE TO RELATED APPLICATIONS

This application claims the benefit of priority of U.S. Provisional Patent Application No. 62/458,287 filed Feb. 13, 2017, which is hereby incorporated by reference in its entirety.

### BACKGROUND

### 1. Field of Invention

The present invention relates generally to composite fiber tapes, and more specifically, but not by way of limitation, to methods and systems for producing fiber tapes and/or sizing fibers, and fiber tapes and laminates produced using the same.

### 2. Description of Related Art

Composite laminates can be used to form structures having advantageous structural characteristics, such as high strengths, high stiffnesses, and/or the like, as well as relatively low weights when compared to similar structures formed from conventional materials. As a result, composite laminates are used in a variety of applications across a wide range of industries, including the automotive, aerospace, and consumer electronics industries.

Some laminates comprise fiber tape, which is typically made by impregnating a strand of fibers (e.g., a carbon fiber tow) with a thermoplastic matrix material. In traditional impregnation techniques, a relatively high viscosity matrix material is forced through a dry and relatively low permeability strand of fibers. As a result, traditional impregnation techniques can produce fiber tapes that have relatively low and/or unpredictable fiber volume fractions, relatively uneven distributions of fibers within the tapes, excesses of matrix material, and/or the like, and thus fiber tapes having undesirable and/or unpredictable structural characteristics.

In many applications, it may be desirable for a laminate to be flame retardant. For a traditional laminate, flame retardant properties can be enhanced via the addition of a flame retardant to the matrix material of the laminate. However, the incorporation of a flame retardant in a laminate, in addition to increasing the cost of the laminate, can adversely affect properties of the laminate, such as its heat distortion temperature, hydrolytic stability, ductility, stiffness, and/or the like.

### SUMMARY

Some embodiments of the present disclosure, at least by spreading a strand of fibers into a spreaded fiber layer and immersing the spreaded fiber layer in a solution comprising a polymeric material dissolved in a solvent can be configured to produce a fiber tape having: (1) a relatively high fiber volume fraction (e.g., greater than 55%); (2) an even distribution of fibers within the fiber tape; and/or (3) a predictable fiber volume fraction, which can be adjusted by varying the concentration of the polymeric material in the solution, the period of time for which the fibers are immersed in the solution, a tension in the spreaded fiber layer, and/or the like.

In some embodiments, the solution can comprise a flame retardant (e.g., resorcinol bis (diphenyl phosphate)), which can mitigate deformation (e.g., curling) of the spreaded fiber layer after the spreaded fiber layer is removed from the solution and as solvent from the solution is evaporated from the spreaded fiber layer. In some embodiments, the temperature of the solution during immersion of the spreaded fiber layer is between approximately 18° and approximately 30° Celsius (e.g., approximately 20° C., room temperature, and/or the like). In some embodiments, as solvent from the solution is evaporated from the spreaded fiber layer and/or the spreaded fiber layer is heated to form a fiber tape, the temperature of, within, and/or near the spreaded fiber layer and/or any heat source(s) used to evaporate the solvent and/or form the fiber tape does not exceed approximately 80° C. While the use of certain flame retardants, such as RDP, is known to facilitate extrusion, compounding, and injection molding of thermoplastic materials, such processes are performed at significantly higher temperatures (e.g., greater than 250° C.).

Some embodiments of the present disclosure, at least by spreading a strand of fibers into a spreaded fiber layer and immersing the spreaded fiber layer in a solution comprising a polymeric material dissolved in a solvent can be configured to produce a fiber tape that is flame retardant (e.g., having a UL-94 rating of V-1 or V-0), in some instances, without the addition of a flame retardant, which can be facilitated by the fiber tape having: (1) a relatively high fiber volume fraction (e.g., greater than 55%); (2) an even distribution of fibers within the fiber tape; and/or (3) less and/or smaller pockets of the polymeric material within the fiber tape, less polymeric material on the top and bottom surfaces of the fiber tape, and/or the like, when compared to a fiber tape impregnated by other methods.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially” and “approximately” may be substituted with “within [a percentage] of” what is specified, where the percentage includes 0.1, 1, 5, and 10 percent.

The phrase “and/or” means and or or. To illustrate, A, B, and/or C includes: A alone, B alone, C alone, a combination of A and B, a combination of A and C, a combination of B and C, or a combination of A, B, and C. In other words, “and/or” operates as an inclusive or.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), and “include” (and any form of include, such as “includes” and “including”). As a result, an apparatus that “comprises,” “has,” or “includes” one or more elements possesses those one or more elements, but is not limited to possessing only those one or more elements. Likewise, a method that “comprises,” “has,” or “includes” one or more steps possesses those one or more steps, but is not limited to possessing only those one or more steps.

Any embodiment of any of the apparatuses, systems, and methods can consist of or consist essentially of—rather than comprise/have/include—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Some details associated with the embodiments are described above, and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. The figures are drawn to scale (unless otherwise noted), meaning the sizes of the depicted elements are accurate relative to each other for at least the embodiment depicted in the figures. Views identified as schematics are not drawn to scale.

FIG. 1 is a flow chart of some embodiments of the present methods for producing fiber tapes and/or sizing fibers, including immersing a spreaded fiber layer in a solution comprising a polymeric material dissolved in a solvent.

FIG. 2 is a side view of an embodiment of the present systems that may be suitable for performing some embodiments of the present methods for producing fiber tapes and/or sizing fibers.

FIG. 3 is a schematic view of a bath that may be suitable for use in some embodiments of the present methods and/or systems.

FIG. 4 is a schematic cross-sectional end view of a spreaded fiber layer showing deformation that may occur after the spreaded fiber layer is immersed in a solution comprising a polymeric material dissolved in a solvent.

FIG. 5 is a schematic view of a pressing element that may be suitable for use in some embodiments of the present methods and/or systems.

FIG. 6 is a schematic cross-sectional end view of a fiber tape that may be produced using some embodiments of the present methods and/or systems.

FIGS. 7A-7F are scanning electron microscope (SEM) images of fiber tapes produced using some embodiments of the present methods at different concentrations of the polymeric material in the solution.

FIGS. 8 and 9 are graphs of fiber volume fraction vs. line speed for fiber tapes produced using some embodiments of the present methods at different concentrations of the polymeric material in the solution.

FIGS. 10A and 10B are SEM images of a fiber tape produced using some embodiments of the present methods.

FIG. 11 is a graph of burn length vs. fiber volume fraction for fiber tapes produced using some embodiments of the present methods.

FIGS. 12A and 12B are SEM images of a comparative fiber tape and a fiber tape produced using some embodiments of the present methods, respectively.

### DETAILED DESCRIPTION

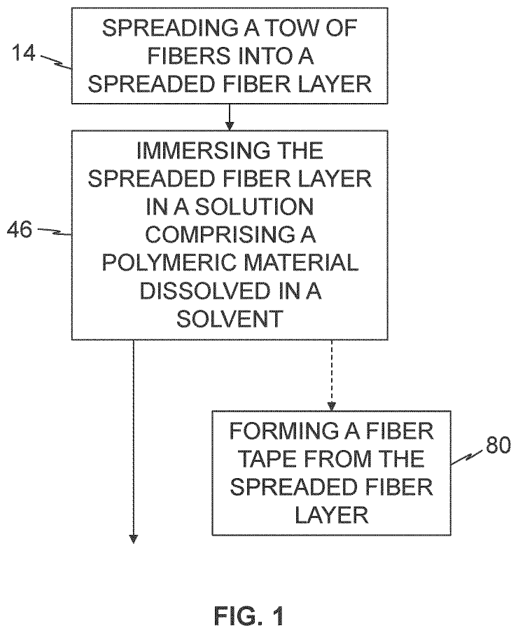

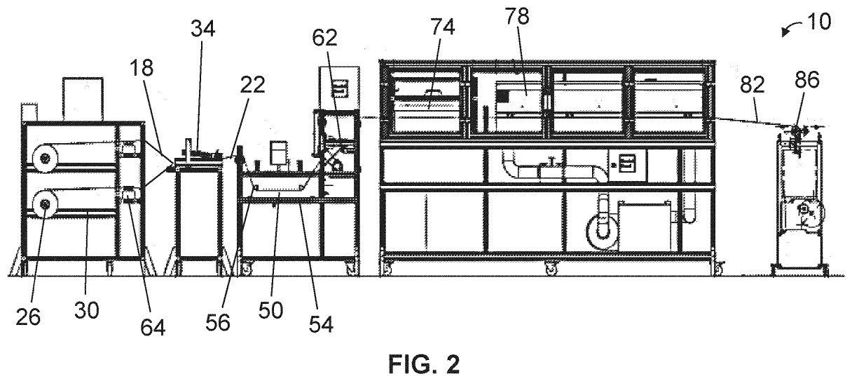

FIG. 1 depicts some embodiments of the present methods for producing fiber tapes and/or sizing fibers, and FIG. 2 depicts an embodiment 10 of the present systems that may be suitable for performing at least some of the methods of FIG. 1. Throughout this disclosure, system 10 is referenced to illustrate at least some of the methods of FIG. 1; however, system 10 is not limiting on the methods of FIG. 1, which can be performed using any suitable system.

Some embodiments of the present methods comprise a step 14 of spreading a strand of fibers (e.g., 18), which may be referred to as filaments, into a spreaded fiber layer (e.g., 22). The strand of fibers can comprise any suitable fibers, such as, for example, glass fibers, carbon fibers, aramid fibers, polyethylene fibers, polyester fibers, polyamide fibers, ceramic fibers, basalt fibers, steel fibers, and/or the like. The strand of fibers can include any suitable number of fibers (e.g., between 250 and 610,000 fibers) (e.g., 1K, 3K, 6K, 12K, 24K, 50K, or larger strands can be used). As used herein, a “strand” includes a roving or a tow. To illustrate, a strand of fibers 18 can be disposed around a spool 26 from which the fibers can be unwound.

Spool 26 can be supported on a creel 30. Strand of fibers 18 can be directed from spool 26 and to a spreader 34 to spread the strand of fibers into a spreaded fiber layer 22. Spreader 34 can comprise any suitable spreader. For example, spreader 34 can include one or more spreader elements (e.g., rod(s), whether or not rotatable (e.g., a roller is an example of a rod), plate(s), and/or the like) over and/or under which strand of fibers 18 can be passed to spread the strand of fibers into spreaded fiber layer 22. To facilitate such spreading, the spreader element(s) can include lobe(s), convexit(ies), protrusion(s), groove(s), and/or the like and can be heated, vibrated, rotated relative to strand of fibers 18, oscillated relative to the strand of fibers, and/or the like.

Some embodiments of the present methods comprise a step 46 of immersing a spreaded fiber layer (e.g., 22) in a solution (e.g., 50) comprising a polymeric material dissolved in a solvent. The solution can comprise greater than or approximately equal to any one of, or between any two of: 1, 2, 3, 4, 5, 6, 7, 8, 9, 10, 12, 14, 16, 18, 20, 22, 24, 26, 28, 30, 32, 34, 36, 38, 40, 42, 44, 46, 48, 50, 52, 54, 56, 58, or 60% of the polymeric material by weight (e.g., between approximately 5% and approximately 20% of the polymeric material by weight) (e.g., at least 2, 3, 4, 5, 6, 7, 8, 9, or 10% of the polymeric material by weight). The temperature of the solution during immersion of the spreaded fiber layer may be, for example, between approximately 18° Celsius (C) to and approximately 30° C. (e.g., approximately 20° C., room temperature, and/or the like).

The polymeric material can include a thermoplastic polymer, such as, for example, polyethylene terephthalate, polycarbonate (PC), polybutylene terephthalate (PBT), poly(1,4-cyclohexylidene cyclohexane-1,4-dicarboxylate) (PCCD), glycol-modified polycyclohexyl terephthalate (PCTG), poly(phenylene oxide) (PPO), polypropylene (PP), polyethylene (PE), polyvinyl chloride (PVC), polystyrene (PS), polymethyl methacrylate (PMMA), polyethyleneimine or polyetherimide (PEI) or a derivative thereof, a thermoplastic elastomer (TPE), a terephthalic acid (TPA) elastomer, poly(cyclohexanedimethylene terephthalate) (PCT), polyethylene naphthalate (PEN), a polyamide (PA), polystyrene sulfonate (PSS), polyether ether ketone (PEEK), polyether ketone ketone (PEKK), acrylonitrile butyldiene styrene (ABS), polyphenylene sulfide (PPS), a copolymer thereof, or a blend thereof. The polymeric material can comprise a thermoset material, such as, for example, an unsaturated polyester resin, a polyurethane, bakelite, duroplast, urea-formaldehyde, diallyl-phthalate, epoxy resin, an epoxy vinylester, a polyimide, a cyanate ester of a polycyanurate, dicyclopentadiene, a phenolic, a benzoxazine, a co-polymer thereof, or a blend thereof.

Polycarbonate polymers suitable for use in the present disclosure can have any suitable structure. For example, such a polycarbonate polymer can include a linear polycarbonate polymer, a branched polycarbonate polymer, a polyester carbonate polymer, or a combination thereof. Such a polycarbonate polymer can include a polycarbonate-polyorganosiloxane copolymer, a polycarbonate-based urethane resin, a polycarbonate polyurethane resin, or a combination thereof.

Such a polycarbonate polymer can include an aromatic polycarbonate resin. For example, such aromatic polycarbonate resins can include the divalent residue of dihydric phenols bonded through a carbonate linkage and can be represented by the formula:

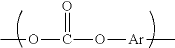

where Ar is a divalent aromatic group. The divalent aromatic group can be represented by the formula: —Ar₁—Y—Ar₂—, where Ar₁ and Ar₂ each represent a divalent carbocyclic or heterocyclic aromatic group having from 5 to 30 carbon atoms (or a substituent therefor) and Y represents a divalent alkane group having from 1 to 30 carbon atoms. For example, in some embodiments, —Ar₁—Y—Ar₂— is Ar₁—C(CH₃)—Ar₂, where Ar₁ and Ar₂ are the same. As used herein, “carbocyclic” means having, relating to, or characterized by a ring composed of carbon atoms. As used herein, “heterocyclic” means having, relating to, or characterized by a ring of atoms of more than one kind, such as, for example, a ring of atoms including a carbon atom and at least one atom that is not a carbon atom. “Heterocyclic aromatic groups” are aromatic groups having one or more ring nitrogen, oxygen, or sulfur atoms.

In some embodiments, Ar₁ and Ar₂ can each be substituted with at least one substituent that does not affect the polymerization reaction. Such a substituent can include, for example, a halogen atom, an alkyl group having from 1 to 10 carbon atoms, an alkoxy group having from 1 to 10 carbon atoms, a phenyl group, a phenoxy group, a vinyl group, a cyano group, an ester group, an amide group, or a nitro group.

Aromatic polycarbonate resins suitable for use in the present disclosure can be commercially available, such as, for example, Lexan® HF1110, available from SABIC Innovative Plastics (U.S.A.), or can be synthesized using any method known by those skilled in the art.

Polycarbonate polymers for use in the present disclosure can have any suitable molecular weight; for example, an average molecular weight of such a polycarbonate polymer can be from approximately 5,000 to approximately 40,000 grams per mol (g/mol).

The solvent can comprise any suitable solvent that is capable of dissolving the polymeric material. Non-limiting examples of such solvents include chloroform, dichloromethane, bromochloromethane, cis-1,2-dichloroethylene, 1,1,2-trichloroethane, 1,1,1,2-tetrachloroethane, 1,1,2,2-tetrachloroethane, 2,5-dihydrofuran, furan, 2-methyltetrahydrofuran, 1,3-dioxolane, N,N-dimethylformamide, ethyl acetate, methyl tert-butylether, cyclopentanone, and toluene.

As will be described in more detail below, the solution may or may not comprise a flame retardant. Such a flame retardant can include phosphate structures (e.g., resorcinol bis(diphenyl phosphate) (RDP)), a sulfonated salt, halogen, phosphorous, talc, silica, a hydrated oxide, a brominated polymer, a chlorinated polymer, a phosphorated polymer, a nanoclay, an organoclay, polyphosphonates, a poly[phosphonate-co-carbonate], a polytetrafluorethylene and styrene-acrylonitrile copolymer, a polytetrafluoroethylene and methyl methacrylate copolymer, a polysiloxane copolymer, and/or the like.

At least by diluting the polymeric material, the solution can allow polymeric material to reach interstices between individual fibers of the spreaded fiber layer that the polymeric material, if undiluted, might be too viscous to reach. For example, the immersing can be performed such that, once the spreaded fiber layer is no longer immersed in the solution, the solution, and thus polymeric material dissolved in the solution, forms a coating on (but not necessarily completely around) each of substantially all of the fibers of the spreaded fiber layer. In at least this way, such immersing can facilitate the production of fiber tapes having relatively high fiber volume fractions (e.g., greater than 55%), even distributions of fibers within the fiber tapes, predictable fiber volume fractions (described in more detail below), and/or the like.

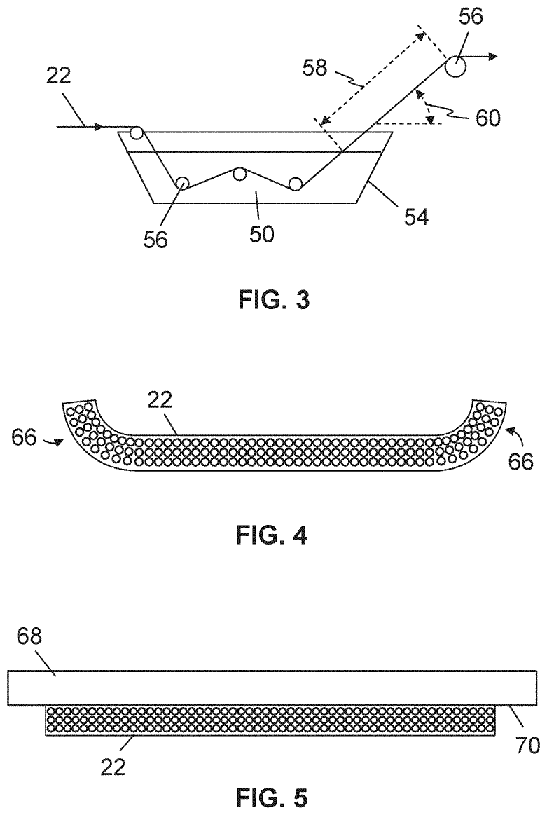

To illustrate, and referring additionally to FIG. 3, a solution 50 comprising a polymeric material dissolved in a solvent can be disposed in a bath 54 (e.g., a container). Spreaded fiber layer 22 can be directed through bath 54 by one or more rods or plates 56 (e.g., including rod(s) and/or plate(s)) to immerse the spreaded fiber layer in solution 50. One or more of rod(s) or plate(s) 56 can be disposed downstream of and above solution 50 in bath 54 such that a length 58 of spreaded fiber layer 22 that has exited the solution is angularly disposed relative to a horizontal plane at an angle 60. Length 58 can be any suitable length, and angle 60 can be any suitable angle (and can vary along the length). For example, angle 60 can be greater than or approximately equal to any one of, or between any two of: 5, 10, 15, 20, 25, 30, 35, 40, 45, 50, 55, 60, 65, 70, 75, 80, 85, or 90°. Such an angularly disposed portion of spreaded fiber layer 22 can encourage excess solution on the spreaded fiber layer to flow along the spreaded fiber layer (e.g., to return to bath 54). In some embodiments, after passing through a bath (e.g., 54), a spreaded fiber layer (e.g., 22) can be directed through a nip roller (e.g., 62, FIG. 2) to remove excess solution.

Some embodiments of the present methods comprise tensioning the strand of fibers and/or the spreaded fiber layer while spreading the strand of fibers into the spreaded fiber layer and/or immersing the spreaded fiber layer in the solution, which can facilitate spreading of the strand of fibers into the spreaded fiber layer and/or impregnation of the spreaded fiber layer with the solution. For example, the tensioning can be performed such that tension in the strand of fibers and/or the spreaded fiber layer is approximately 1 newton (N). To illustrate, spool 26 and/or creel 30 can be configured to resist unwinding of strand of fibers 18 from the spool, a tensioner 64 for tensioning the strand of fibers and/or spreaded fiber layer 22 can be disposed upstream of spreader 34 and/or bath 54, and/or the like.

Some embodiments of the present methods comprise evaporating at least a portion of the solution (e.g., the solvent) from the spreaded fiber layer. To illustrate, once spreaded fiber layer 22 is removed from solution 50, the spreaded fiber layer can be air-dried, passed by an infrared heat source 74, through a hot air oven 78, and/or the like to evaporate at least a portion of the solution from the spreaded fiber layer.

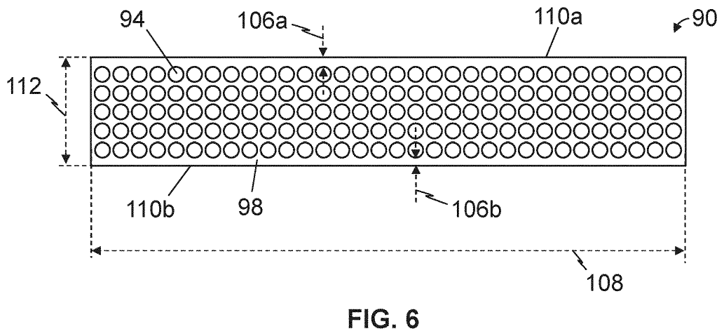

Referring additionally to FIG. 4, in some instances, when evaporating at least a portion of a solution (e.g., 50) from a spreaded fiber layer (e.g., 22), deformation of the spreaded fiber layer may occur. To illustrate, ends (e.g., 66) of the spreaded fiber layer may curl and, in some cases, fold over onto other portions of the spreaded fiber layer. Such a deformed spreaded fiber layer may be undesirable; for example, the spreaded fiber layer may be difficult to wind, require trimming (e.g., creating scrap), discourage uniform evaporation of the solution from the spreaded fiber layer (e.g., causing residual stresses in and/or non-uniform impregnation of the spreaded fiber layer), and/or the like.

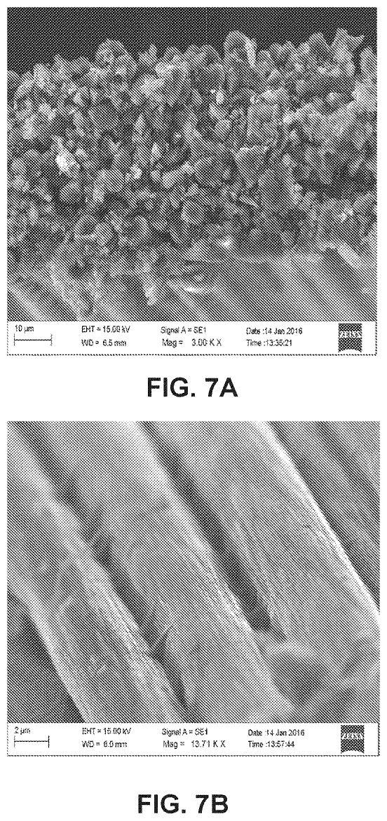

Referring additionally to FIG. 5, in some embodiments, after a spreaded fiber layer (e.g., 22) is removed from a solution (e.g., 50), the spreaded fiber layer can be contacted with one or more rods or plates (e.g., 68) to discourage and/or correct deformation of the spreaded fiber layer as at least a portion of the solution is evaporated from the spreaded fiber layer. For example, each of the rod(s) or plate(s) can have a surface (e.g., 70) for contacting the spreaded fiber layer, which can be planar (e.g., FIG. 5) or curved (e.g., along a direction that is parallel to and/or a direction that is transverse to fibers of the spreaded fiber layer). The spreaded fiber layer can be passed over and/or under the rod(s) or plate(s) in contact with the surface(s) such that the surface(s) discourage and/or correct deformation of the spreaded fiber layer. For each of the rod(s) or plate(s), a force applied between the spreaded fiber layer and the rod or plate can be adjusted by, for example, varying a tension in the spreaded fiber layer, a position of the rod or plate relative to the spreaded fiber layer, and/or the like. The rod(s) or plate(s) can each be disposed at any suitable location within a system (e.g., 10), such as, for example, downstream of a bath (e.g., 54), downstream of rod(s) or plate(s) (e.g., 56) for directing the spreaded fiber layer through the bath, downstream of a nip roller (e.g., 62), a location such that the rod or plate contacts a portion of the spreaded fiber layer that is being heated (e.g., at, proximate to, and/or within infrared heat source 74, hot air oven 78, and/or the like).

In some embodiments, the inclusion of a flame retardant in a solution (e.g., 50) can reduce or eliminate deformation of a spreaded fiber layer (e.g., 22) after the spreaded fiber layer is immersed in and removed from the solution. For example, the solution can comprise greater than or approximately equal to any one of, or between any two of: 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 3.0, 3.5, 4.0, 4.5, or 5.0% of the flame retardant by weight (e.g., approximately 1.5% of the flame retardant by weight). The flame retardant can comprise any suitable flame retardant, such as, for example, any one or more of those described above, and preferably includes RDP. Without wishing to be bound to any particular theory, deformation-resistant properties provided to the spreaded fiber layer by the inclusion of the flame retardant in the solution may be a result of the flame retardant: (1) altering the rate at which solvent in the solution evaporates from the spreaded fiber layer; (2) encouraging a uniform rate of solvent evaporation from the spreaded fiber layer across its width; (3) enhancing impregnation of the spreaded fiber layer with the solution; and/or the like.

In some embodiments of the present methods, an amount of polymeric material deposited onto fibers of the spreaded fiber layer due to immersion in the solution can be adjusted by, for example: (1) varying the composition of the solution (e.g., the concentration of polymeric material, flame retardant, and/or the like in the solution, the boiling point of solvent used in the solution, and/or the like); (2) varying the period of time for which the spreaded fiber layer is immersed in the solution (e.g., by varying the line speed at which the spreaded fiber layer is passed through bath 54, the size of the bath, the number of times the spreaded fiber layer is passed through the bath, the number of baths that the spreaded fiber layer is passed through, and/or the like); (3) varying tension in the strand of fibers and/or the spreaded fiber layer; (4) varying the angle (e.g., 60) at which a portion of the spreaded fiber layer that has exited the bath is disposed relative to a horizontal plane and the length (e.g., 58) of that portion; and/or the like.

At least by allowing for control over an amount of polymeric material deposited onto fibers of a spreaded fiber layer (e.g., 22), some embodiments of the present methods can be used to produce fiber tapes having predictable fiber volume fractions. For example, Table 1 includes estimated fiber volume fractions for fiber tapes having fibers with different diameters and polymeric coating thicknesses.

TABLE 1
Estimated Fiber Volume Fractions for Fiber Tapes having Fibers with
Different Diameters and Polymeric Material Coating Thicknesses

| Fiber | | | | | | |
|---|---|---|---|---|---|---|
| Diameter | | | | | | |
| (μm) | Polymeric Material Coating Thickness (μm) | | | | | |
| 6 | 1.74 | 1.47 | 1.24 | 1.05 | 0.87 | 0.72 |
| 8 | 2.32 | 1.96 | 1.66 | 1.39 | 1.16 | 0.96 |
| 10 | 2.91 | 2.45 | 2.07 | 1.74 | 1.45 | 1.2 |
| Estimated | 40 | 45 | 50 | 55 | 60 | 65 |
| Fiber | | | | | | |
| Volume | | | | | | |
| Fraction | | | | | | |

Some embodiments of the present methods can be used to size fibers of a strand of fibers (e.g., 18). Sizing is a process in which fibers are coated with a material in order to protect the fibers from damage (e.g., splitting) during processing, enhance adhesion between the fibers and materials that are subsequently applied to the fibers, and/or the like. For example, at least by contacting fibers from the strand of fibers with a solution (e.g., 50) comprising a polymeric material dissolved in a solvent, some embodiments of the present methods can be used to size the fibers with the polymeric material. Such contacting can be performed by immersing the fibers in the solution (as described above), cascading the solution onto the fibers, brushing the solution onto the fibers, spraying the solution onto the fibers, and/or the like. Once sized with the polymeric material, such fibers can be disposed around a spool (e.g., in the form of a strand) for later use in making fiber tapes or laminates. In some instances, such fibers can be woven into textiles and/or fabrics.

In some embodiments of the present methods, the strand of fibers (e.g., prior to contact with the solution) can comprise unsized fibers. Such unsized fibers may be uncoated and/or may not comprise a sizing material such as, for example, epoxy, polyester, nylon, polyurethane, polyether, urethane, a coupling agent (e.g., an alkoxysilane), a lubricating agent, an antistatic agent, a surfactant, and/or the like.

Some embodiments of the present methods comprise a step 80 of forming a fiber tape (e.g., 82) from a spreaded fiber layer (e.g., 22) by applying heat and/or pressure to the spreaded fiber layer. To illustrate, pressure can be applied to spreaded fiber layer 22 to form a fiber tape 82 by passing the spreaded fiber layer through nip roller 62 and/or passing the spreaded fiber layer over and/or under one or more pressing elements (e.g., rod(s) and/or plate(s)). To further illustrate, heat can be applied to spreaded fiber layer 22 to form fiber tape 82 by passing the spreaded fiber layer by infrared heat source 74, passing the spreaded fiber layer through hot air oven 78, heating nip roller 62, heating one or more of the pressing element(s), using other heat source(s) (e.g., heated platen(s)), and/or the like. In some instances, during heating of spreaded fiber layer 22, the temperature of and/or within the spreaded fiber layer, hot air oven 78, nip roller 62, any heated pressing element(s), and/or other heat source(s) and/or the temperature of and/or near infrared heat source 74 does not exceed approximately 80° C. Fiber tape 82 can be disposed around a spool (e.g., using winder 86) for later use as fiber tape and/or as pl(ies) in a laminate.

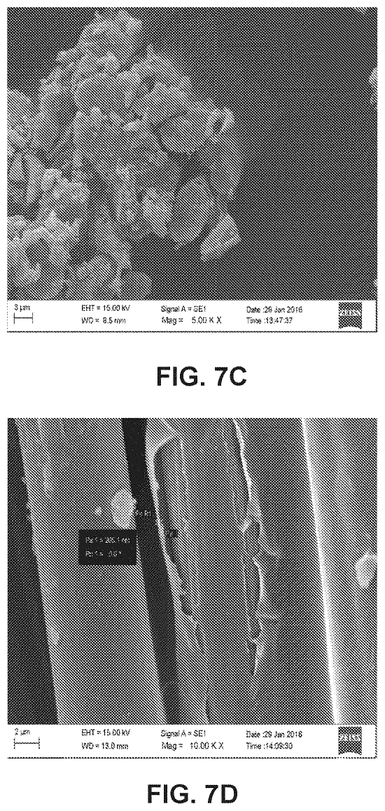

Referring additionally to FIG. 6, shown is a schematic cross-sectional end view of a fiber tape 90 of the present disclosure, including fibers 94 dispersed within a polymeric material 98. As shown, in part because polymeric material 98 coats each of substantially all of fibers 94, the fibers may be more evenly distributed within the polymeric material, there may be less and/or smaller pockets of the polymeric material within the fiber tape, there may be less polymeric material on top and bottom surfaces, 110a and 110b, respectively, of the fiber tape, and/or the like, when compared to a fiber tape impregnated by other methods.

For example, an average distance 106a between top surface 110a of fiber tape 90 and a nearest one of fibers 94 can be less than approximately 20 micrometers (μm) (e.g., less than approximately 19, 18, 17, 16, 15, 14, 13, 12, 11, or 10 μm). To illustrate, each point on top surface 110a can be disposed a distance from the one of fibers 94 that is nearest to that point, and average distance 106a can be the average of such distances. For further example, an average distance 106b between bottom surface 110b of fiber tape 90 and a nearest one of fibers 94 can be less than approximately 20 μm (e.g., less than approximately 19, 18, 17, 16, 15, 14, 13, 12, 11, or 10 μm). To illustrate, each point on bottom surface 110b can be disposed a distance from the one of fibers 94 that is nearest to that point, and average distance 106b can be the average of such distances. For a given fiber tape (e.g., 90), such average distance(s) (e.g., 106a, 106b) can be determined across a width (e.g., 108) of the fiber tape (e.g., across 80, 85, 90, 95, or 100% of the width of the fiber tape), and, in some instances, not along a length of the fiber tape (e.g., considering the fiber tape in cross-section).

A fiber tape (e.g., 82, 90) of the present disclosure can have any suitable thickness, such as, for example, an average thickness (e.g., 112) that is greater than or approximately equal to any one of, or between any two of: 0.04, 0.05, 0.06, 0.07, 0.08, 0.09, 0.10, 0.12, 0.14, 0.16, 0.18, 0.20, 0.22, 0.24, 0.26, 0.28, 0.30, 0.32, 0.34, 0.36, 0.38, or 0.40 millimeters (mm). A fiber tape (e.g., 82, 90) of the present disclosure can have any suitable fiber volume fraction, such as, for example, a fiber volume fraction that is greater than or approximately equal to any one of, or between any two of: 35, 40, 45, 50, 55, 60, 65, 70, 75, 80, 85, 90, or 95%.

A fiber tape (e.g., 82, 90, and/or the like) of the present disclosure may be flame retardant (e.g., having a UL-94 rating of V-1 or V-0), in some instances, without comprising a flame retardant (e.g., without including any one or more of the flame retardants described above). Such flame retardant properties can be provided, at least in part, by the fiber tape having relatively few and/or relatively small pockets of polymeric material (e.g., 98) within the fiber tape, relatively little polymeric material (e.g., 98) disposed on top and bottom surfaces (e.g., 110a and 110b, respectively) of the fiber tape, a relatively high fiber volume fraction, and/or the like (e.g., when compared to a fiber tape impregnated by other methods), each of which may discourage flame propagation along the fiber tape.

Some embodiments of the present methods for producing a fiber tape comprise: spreading a strand of fibers into a spreaded fiber layer, immersing the spreaded fiber layer in a solution comprising a polymeric material dissolved in a solvent, and forming a fiber tape from the spreaded fiber layer by applying heat and/or pressure to the spreaded fiber layer. Some embodiments of the present methods for sizing fibers comprise: spreading a strand of unsized fibers into a spreaded fiber layer, immersing the spreaded fiber layer in a solution, the solution comprising a polymeric material dissolved in a solvent, and evaporating at least a portion of the solution from the spreaded fiber layer.

In some embodiments, the immersing the spreaded fiber layer in the solution comprises passing the spreaded fiber layer through a bath of the solution. In some embodiments, the solution comprises between approximately 5% and approximately 30% of the polymeric material by weight. In some embodiments, the polymeric material comprises a thermoplastic polymer. In some embodiments, the thermoplastic polymer comprises polyethylene terephthalate, polycarbonate (PC), polybutylene terephthalate (PBT), poly(1,4-cyclohexylidene cyclohexane-1,4-dicarboxylate) (PCCD), glycol-modified polycyclohexyl terephthalate (PCTG), poly(phenylene oxide) (PPO), polypropylene (PP), polyethylene (PE), polyvinyl chloride (PVC), polystyrene (PS), polymethyl methacrylate (PMMA), polyethyleneimine or polyetherimide (PEI) or a derivative thereof, a thermoplastic elastomer (TPE), a terephthalic acid (TPA) elastomer, poly(cyclohexanedimethylene terephthalate) (PCT), polyethylene naphthalate (PEN), a polyamide (PA), polysulfone sulfonate (PSS), polyether ether ketone (PEEK), polyether ketone ketone (PEKK), acrylonitrile butyldiene styrene (ABS), polyphenylene sulfide (PPS), a copolymer thereof, or a blend thereof. In some embodiments, the polymeric material comprises a polycarbonate material.

In some embodiments, the solvent comprises chloroform, dichloromethane, bromochloromethane, cis-1,2-dichloroethylene, 1,1,2-trichloroethane, 1,1,1,2-tetrachloroethane, 1,1,2,2-tetrachloroethane, 2,5-dihydrofuran, furan, 2-methyltetrahydrofuran, 1,3-dioxolane, N,N-dimethylformamide, ethyl acetate, methyl tert-butylether, cyclopentanone, and/or toluene.

In some embodiments, the fiber tape does not comprise a flame retardant. In some embodiments, the solution comprises a flame retardant. In some embodiments, the solution comprises between approximately 1% and approximately 5% of the flame retardant by weight. In some embodiments, the flame retardant comprises a phosphate structure, resorcinol bis(diphenyl phosphate), a sulfonated salt, halogen, phosphorous, talc, silica, a hydrated oxide, a brominated polymer, a chlorinated polymer, a phosphorated polymer, a nanoclay, an organoclay, a polyphosphonate, a poly[phosphonate-co-carbonate], a polytetrafluorethylene and styrene-acrylonitrile copolymer, a polytetrafluoroethylene and methyl methacrylate copolymer, and/or a polysiloxane copolymer.

In some embodiments, the fibers comprise glass fibers, carbon fibers, aramid fibers, polyethylene fibers, polyester fibers, polyamide fibers, ceramic fibers, basalt fibers, and/or steel fibers. In some embodiments, the fibers of the strand are unsized. In some embodiments, the unsized fibers do not comprise one or more of: epoxy, polyester, nylon, polyurethane, polyether, and urethane, and/or are uncoated.

In some embodiments, the fiber tape does not comprise a flame retardant, and the fiber tape has a UL-94 rating of V-0. In some embodiments, the fiber tape comprises between approximately 40% and approximately 95% of the fibers by volume and/or the fiber tape has an average thickness that is between approximately 0.05 millimeters (mm) and approximately 0.30 mm.

Some embodiments of the present fiber tapes comprise: a plurality of fibers dispersed within a polymeric material, substantially all of the fibers being substantially parallel to one another, wherein the fiber tape does not comprise a flame retardant, and wherein the plurality of fibers are dispersed within the polymeric material such that the fiber tape has a UL-94 rating of V-0. In some embodiments, the flame retardant comprises a phosphate structure, resorcinol bis(diphenyl phosphate), a sulfonated salt, halogen, phosphorous, talc, silica, a hydrated oxide, a brominated polymer, a chlorinated polymer, a phosphorated polymer, a nanoclay, an organoclay, a polyphosphonate, a poly[phosphonate-co-carbonate], a polytetrafluorethylene and styrene-acrylonitrile copolymer, a polytetrafluoroethylene and methyl methacrylate copolymer, and/or a polysiloxane copolymer.

In some embodiments, an average distance between a bottom surface of the fiber tape and a nearest one of the fibers is less than approximately 15 μm, optionally, less than approximately 10 μm, and an average distance between a top surface of the fiber tape and a nearest one of the fibers is less than approximately 15 μm, optionally, less than approximately 10 μm.

In some embodiments, the fibers comprise glass fibers, carbon fibers, aramid fibers, polyethylene fibers, polyester fibers, polyamide fibers, ceramic fibers, basalt fibers, and/or steel fibers.

### EXAMPLES

The present invention will be described in greater detail by way of specific examples. The following examples are offered for illustrative purposes only and are not intended to limit the invention in any manner. Those of skill in the art will readily recognize a variety of noncritical parameters that can be changed or modified to yield essentially the same results.

### Example 1

Fiber Tapes Produced using Solutions having Different Concentrations of Polymeric Material

Three sample fiber tapes (samples 1-3) were produced as follows. First, a solution was prepared (having a volume of at least 1 liter) by dissolving polycarbonate (Lexan® HF1110, SABIC Innovative Plastics) pellets in dichloromethane, which was facilitated by a shaker, and the solution was poured into a bath. A tow of carbon fibers (12K size; Formosa TC-35; unsized fibers) was spread into a spreaded fiber layer and subsequently passed through the bath. From the bath, the spreaded fiber layer was directed through a nip roller to remove excess solution. Finally, an infrared heater and a hot air oven were used to evaporate dichloromethane from the spreaded fiber layer.

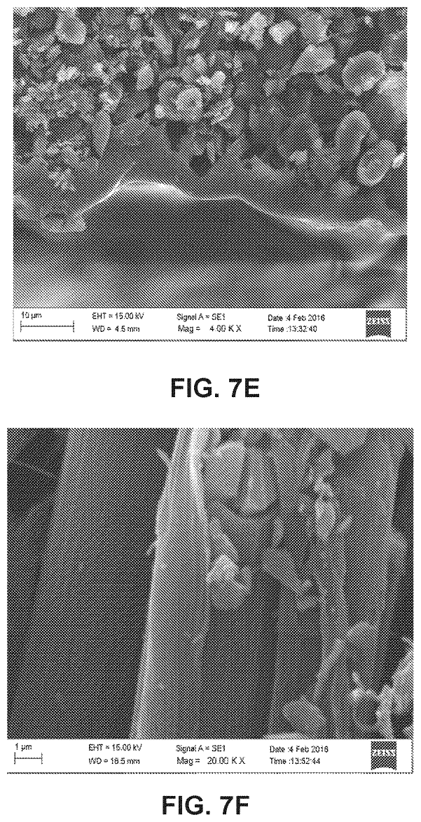

For sample 1, the solution had 5% polycarbonate by weight, for sample 2, the solution had 7% polycarbonate by weight, and, for sample 3, the solution had 10% polycarbonate by weight. For each of the three samples, line speed was 1 meter per minute (m/min), tension in the spreaded fiber layer was 1 N, temperature within the infrared heater was 40° C., and temperature within the hot air oven was 90° C. FIGS. 7A and 7B are SEM images of sample 1, FIGS. 7C-7D are SEM images of sample 2, and FIGS. 7E and 7F are SEM images of sample 3. Properties of samples 1-3 are shown in Table 2.

TABLE 2
Fiber Tapes Produced using Solutions having Different Concentrations of
Polymeric Material

| | Concentration | | | | |
|---|---|---|---|---|---|
| | of | | Fiber | | |
| | Polycarbonate | Tape | Volume | Tape | Residual |
| Sam- | in the Solution | Width | Fraction | Thickness | Dichloromethane |
| ple | (% by weight) | (mm) | (%) | (mm) | (ppm) |
| 1 | 5 | 7 | ~89 | 0.12-0.15 | |
| 2 | 7 | 8 | ~82 | 0.14-0.16 | 300 (50) |
| 3 | 10 | 8 | ~79 | 0.14-0.16 | 450 (50) |

As shown in Table 2, the fiber volume fraction of the three samples was relatively high. This is due, in part, to polycarbonate from the solution forming a coating on each of substantially all of the fibers (FIGS. 7A-7F).

### Example 2

### Fiber Tapes Produced Using Different Line Speeds

### A. Using a Solution Having 5% Polycarbonate by Weight

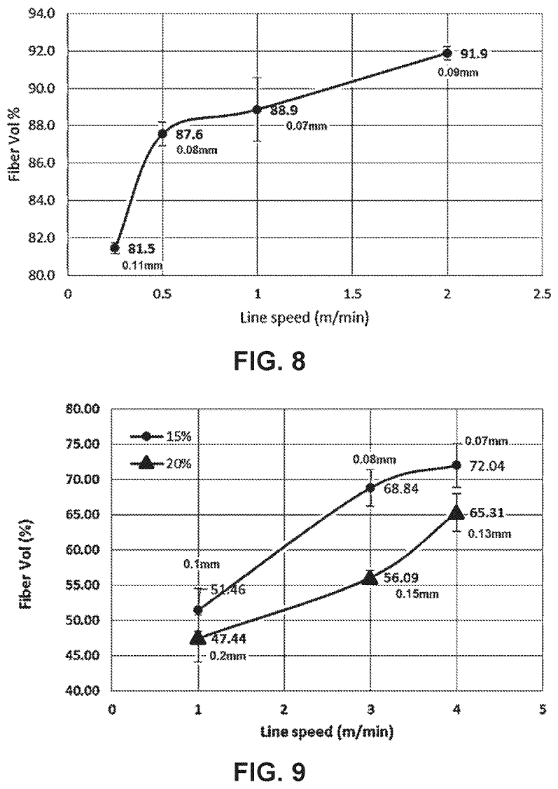

The process described in Example 1 was performed using a solution having 5% polycarbonate by weight at line speeds of 0.25, 0.50, 1.00, and 2.00 m/min. FIG. 8 is graph of fiber volume fraction vs. line speed for the resulting fiber tapes, including fiber tape thicknesses in mm. As shown, fiber volume fraction was found to increase with increasing line speed, which may be due to less polycarbonate depositing onto the fibers as residence time of the fibers in the bath decreases.

### B. Using Solutions Having 15% and 20% Polycarbonate by Weight

The process described in Example 1 was performed using solutions having 15% and 20% polycarbonate by weight at line speeds of 1, 3, and 4 m/min. FIG. 9 is a graph of fiber volume fraction vs. line speed for the resulting fiber tapes, including fiber tape thicknesses in mm. As shown, fiber volume fraction was found to decrease with increasing concentration of polycarbonate in the solution, which may be due to more polycarbonate depositing onto the fibers when the fibers are immersed in solutions having higher polycarbonate concentrations.

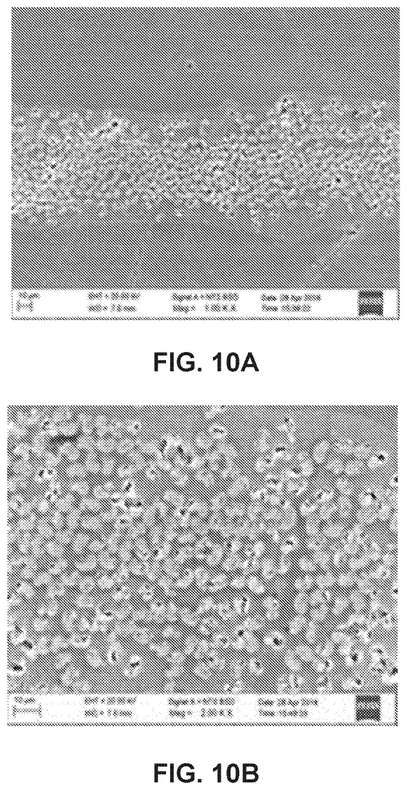

FIGS. 10A and 10B are SEM images of the fiber tape produced using the solution having 15% polycarbonate by weight at the line speed of 3 m/min. As shown, even at 15% polycarbonate by weight, the solution was able to fill interstices between the fibers, resulting in each of substantially all of the fibers being coated with polycarbonate. In the example fiber tape of FIGS. 10A and 10B, polycarbonate formed layers at the top and bottom surfaces of the tape that each had an average thickness of approximately 10 μm.

### Example 3

### Fiber Tapes Having Flame Retardant Properties

In the following example, fiber tapes were produced using the process described in Example 1, and laminates were produced using those fiber tapes. For the fiber tapes and in this example, no flame retardant was included in the solution or otherwise applied to the fibers.

### A. Carbon Fiber Tapes

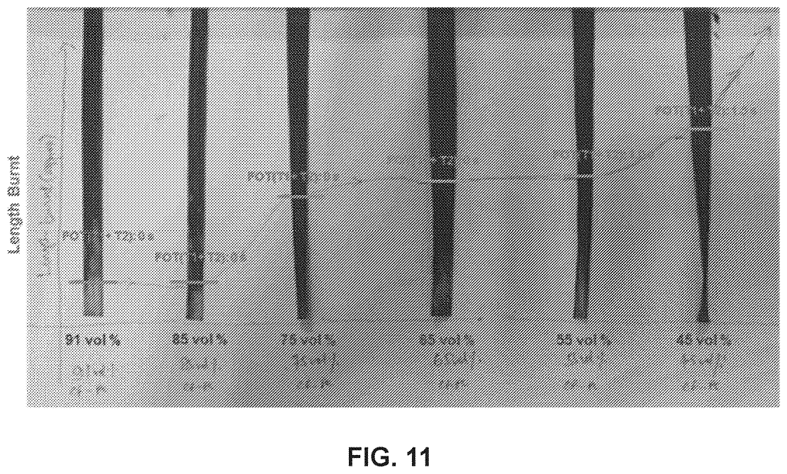

Carbon fiber tapes were produced having thicknesses ranging from approximately 0.08 mm to 0.20 mm, and these tapes were tested for flammability pursuant to the UL-94 standard. The results are depicted in FIG. 11, which shows burn length vs. fiber volume fraction for the tapes, including tape flame out times (t₁+t₂) in seconds (s). For a given tape, the burn length is the length of the tape that caught fire during testing. As shown, for the produced tapes, both burn length and flame out time were inversely related to fiber volume fraction. Notably, each of the produced tapes had a flame out time that was sufficient for the tape to receive a UL-94 rating of V0.

### B. Carbon Fiber Laminates

A carbon fiber laminate was produced by compression molding carbon fiber tapes of the present disclosure. The compression molding was performed using a SANTEC SHCMP-80 static press at a temperature of 260° C., a maximum pressure of 6 bar, and a time of 11 minutes. The tapes each had a thickness of approximately 0.15 mm and a fiber volume fraction of approximately 57%, and the resulting laminate had a thickness of approximately 0.5 mm. When tested for flammability pursuant to the UL-94 standard, the laminate had a flame out time (t₁+t₂) of 3 s, which was sufficient for the laminate to receive a UL-94 rating of V0.

### C. Glass Fiber Tape

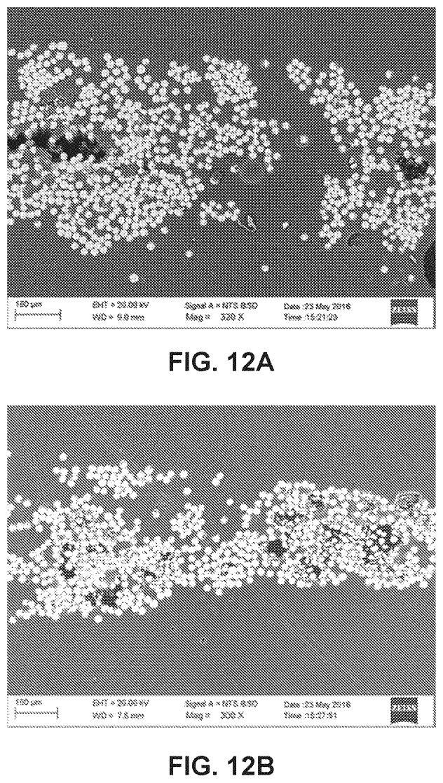

The process described in Example 1, substituting glass fibers (3B E-GF Continuous Roving SE 4220) for carbon fibers, was used to produce a glass fiber tape. In this example, a solution having 15% polycarbonate by weight and a line speed of 3 m/min were used. The produced tape, which is shown in FIG. 12B, had a thickness of approximately 0.21 mm and a fiber volume fraction of approximately 79%. The tape was tested for flammability pursuant to the UL-94 standard and received a UL-94 rating of V0.

### D. Glass Fiber Laminates

A glass fiber laminate was produced by compression molding glass fiber tapes of the present disclosure. The produced laminate had a thickness of approximately 0.5 mm. When tested for flammability pursuant to the UL-94 standard, the laminate received a UL-94 rating of V0.

### Example 4

### Comparison of Fiber Tape of the Present Disclosure with Comparative Fiber Tape

A comparative glass fiber tape (sample 1) was produced by passing a strand of glass fibers over a plate to form a spreaded fiber layer and casting a polycarbonate material over the spreaded fiber layer. No flame retardant was present in the polycarbonate material or otherwise applied to the fibers. The comparative tape, which is shown in FIG. 12A, had a thickness of approximately 0.17 mm and a fiber volume fraction of approximately 71%.

The comparative tape was compared to the glass fiber tape of FIG. 12B (sample 2) by testing each for flammability pursuant to the UL-94 standard, and the results are shown in Table 3.

TABLE 3
Comparison of Fiber Tape of the Present Disclosure with Comparative
Fiber Tape

| | | Fiber | | | |
|---|---|---|---|---|---|
| | Tape | Volume | Flame | Flame | |
| | Thickness | Fraction | Out Time | Out Time | UL-94 |
| Sample | (mm) | (%) | (t₁) (s) | (t₂) (s) | Rating |
| 1 | 0.17 | 71 | Burned to | — | Fail |
| | | | clamp | | |
| 2 | 0.21 | 79 | 1 | 0 | V0 |

As shown, the comparative tape failed during flammability testing by burning to the clamp. This failure may be due, in part, to relatively large pockets of polycarbonate material within the comparative tape (FIG. 12A), many of which extend within the tape an appreciable distance along the fiber direction, the relatively thick layer of polycarbonate at the surface of the tape, and/or the like, each of which may facilitate flame propagation along the tape. In contrast, the tape of the present disclosure received a UL-94 rating of V0, which may be due to smaller pockets of polycarbonate within the tape (FIG. 12B), less polycarbonate on the surface of the tape, and/or the like.

As shown at least in this example, the method of making a fiber tape can affect the flame retardant properties of the fiber tape (and a laminate produced using the fiber tape). Fiber tapes produced using embodiments of the present methods and/or systems can have flame retardant properties (e.g., a UL-94 rating of V-1 or V-0) without the addition of a flame retardant. As a result, fiber tapes produced using embodiments of the present methods and/or systems can meet or exceed the flame retardant properties of fiber tapes produced using other methods (that often necessarily include a flame retardant), while avoiding the increased expense and/or negative effects (e.g., on heat distortion temperature, hydrolytic stability, ductility, stiffness, and/or the like) associated with a flame retardant.

### Example 5

### Fiber Tape Produced Using an Embodiment of the Present Disclosure

A sample fiber tape was produced as follows. First a solution having 15% polycarbonate by weight was prepared by:
(1) placing 750 grams (g) of polycarbonate pellets (21,800 g/mol molecular weight; Lexan® HF1110, SABIC Innovative Plastics) and 4,250 g of dichloromethane into a 10 liter (L) container;
(2) dissolving the polycarbonate pellets in the dichloromethane by shaking the container with a bench shaker overnight (e.g., approximately 8-12 hours). A degassing cap was used to mitigate pressure build-up in the container.
(3) weighing the container to determine the amount of dichloromethane lost due to degassing and replacing the lost dichloromethane; and
(4) pouring the solution into a bath.

Next, six tows of carbon fibers (12K size; Hyosung H2550) were spread into a spreaded fiber layer using a bar-based spreader, and the spreaded fiber layer was passed through the bath. A portion of the spreaded fiber layer downstream of the bath was inclined relative to a horizontal plane. In this example, a line speed of 1 m/min was used.

Prior to heating the solution-coated spreaded fiber layer, a flat metal bar was manually held on the top surface of the spreaded fiber layer to mitigate deformation of the spreaded fiber layer. Finally, the fiber tape was produced by: (1) heating the spreaded fiber layer by passing the spreaded fiber layer between heated platens and through a hot air oven; and (2) applying pressure to the spreaded fiber layer using a calendar roll.

During heating of the spreaded fiber layer, the temperature of air in the hot air oven was 80° C. and the temperature of the heated platens was 70° C. Notably, the process used to produce this tape involved significantly lower temperatures than other processes, such as those involving hot melt extrusion, in which temperatures can exceed 250° C.

### Example 6

### Fiber Tape Produced Using an Embodiment of the Present Disclosure

A sample fiber tape was produced using the process described in Example 5, with the exception that 750 g of polycarbonate pellets, 75 g of RDP, and 4175 g of dichloromethane were placed into the container to produce a solution having 15% polycarbonate by weight and 1.5% RDP by weight. After exiting the bath, the spreaded fiber layer evidenced little to no deformation, and the flat metal bar of Example 5 was not needed to mitigate deformation of the spreaded fiber layer.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A method for producing a fiber tape, the method comprising:
spreading a strand of fibers into a spreaded fiber layer;
passing the spreaded fiber layer through a bath of a solution to immerse the spreaded fiber layer in the solution, the solution comprising:
a polycarbonate material dissolved in a solvent; and
a flame retardant;
wherein the solution comprises between approximately 5% and approximately 30% of the polycarbonate material by weight; and
wherein the solution comprises between approximately 1% and approximately 5% of the flame retardant by weight; and
forming a fiber tape from the spreaded fiber layer by applying heat and/or pressure to the spreaded fiber layer.

2. The method of claim 1, wherein the flame retardant comprises a phosphate structure, resorcinol bis(diphenyl phosphate), a sulfonated salt, halogen, phosphorous, talc, silica, a hydrated oxide, a brominated polymer, a chlorinated polymer, a phosphorated polymer, a nanoclay, an organoclay, a polyphosphonate, a poly[phosphonate-co-carbonate], a polytetrafluorethylene and styrene-acrylonitrile copolymer, a polytetrafluoroethylene and methyl methacrylate copolymer, and/or a polysiloxane copolymer.

3. A method for producing a fiber tape, the method comprising:
spreading a strand of fibers into a spreaded fiber layer;
immersing the spreaded fiber layer in a solution comprising a polymeric material dissolved in a solvent; and
forming a fiber tape from the spreaded fiber layer by applying heat and/or pressure to the spreaded fiber layer;
wherein the fiber tape does not comprise a flame retardant; and
wherein the fiber tape has a UL-94 rating of V-0.

4. The method of claim 3, wherein the immersing the spreaded fiber layer in the solution comprises passing the spreaded fiber layer through a bath of the solution.

5. The method of claim 3, wherein the solution comprises between approximately 5% and approximately 30% of the polymeric material by weight.

6. The method of any claim 3, wherein the polymeric material comprises a thermoplastic polymer.

7. The method of claim 6, wherein the thermoplastic polymer comprises polyethylene terephthalate, polycarbonate (PC), polybutylene terephthalate (PBT), poly(1,4-cyclohexylidene cyclohexane-1,4-dicarboxylate) (PCCD), glycol-modified polycyclohexyl terephthalate (PCTG), poly(phenylene oxide) (PPO), polypropylene (PP), polyethylene (PE), polyvinyl chloride (PVC), polystyrene (PS), polymethyl methacrylate (PMMA), polyethyleneimine or polyetherimide (PEI) or a derivative thereof, a thermoplastic elastomer (TPE), a terephthalic acid (TPA) elastomer, poly(cyclohexanedimethylene terephthalate) (PCT), polyethylene naphthalate (PEN), a polyamide (PA), polysulfone sulfonate (PSS), polyether ether ketone (PEEK), polyether ketone ketone (PEKK), acrylonitrile butyldiene styrene (ABS), polyphenylene sulfide (PPS), a copolymer thereof, or a blend thereof.

8. The method of claim 1, wherein:
the fiber tape comprises between approximately 40% and approximately 95% of the fibers by volume; and/or
the fiber tape has an average thickness that is between approximately 0.05 millimeters (mm) and approximately 0.30 mm.

9. The method of claim 1, wherein the fibers of the strand are unsized.

10. A method for sizing carbon or glass fibers, the method comprising:
spreading a strand of unsized carbon or glass fibers into a spreaded fiber layer;
immersing the spreaded fiber layer in a solution, the solution comprising:
polycarbonate dissolved in a solvent;
wherein the solution comprises between approximately 5% and approximately 30% of the polycarbonate by weight; and
evaporating at least a portion of the solution from the spreaded fiber layer.

11. The method of claim 10, wherein:
the solution comprises between approximately 1% and approximately 5% of a flame retardant by weight; and
optionally, the flame retardant comprises a phosphate structure, resorcinol bis(diphenyl phosphate), a sulfonated salt, halogen, phosphorous, talc, silica, a hydrated oxide, a brominated polymer, a chlorinated polymer, a phosphorated polymer, a nanoclay, an organoclay, a polyphosphonate, a poly[phosphonate-co-carbonate], a polytetrafluorethylene and styrene-acrylonitrile copolymer, a polytetrafluoroethylene and methyl methacrylate copolymer, and/or a polysiloxane copolymer.

12. The method of claim 9, wherein the unsized fibers:
do not comprise one or more of: epoxy, polyester, nylon, polyurethane, polyether, and urethane; and/or
are uncoated.

13. The method of claim 1, wherein the fibers comprise glass fibers, carbon fibers, aramid fibers, polyethylene fibers, polyester fibers, polyamide fibers, ceramic fibers, basalt fibers, and/or steel fibers.

14. The method of claim 1, wherein the solvent comprises chloroform, dichloromethane, bromochloromethane, cis-1,2-dichloroethylene, 1,1,2-trichloroethane, 1,1,1,2-tetrachloroethane, 1,1,2,2-tetrachloroethane, 2,5-dihydrofuran, furan, 2-methyltetrahydrofuran, 1,3-dioxolane, N,N-dimethylformamide, ethyl acetate, methyl tert-butylether, cyclopentanone, and/or toluene.

15. A fiber tape comprising:
a plurality of fibers dispersed within a polymeric material, substantially all of the fibers being substantially parallel to one another;
wherein the fiber tape does not comprise a flame retardant; and
wherein the plurality of fibers are dispersed within the polymeric material such that the fiber tape has a UL-94 rating of V-0.

16. The fiber tape of claim 15, wherein the flame retardant comprises a phosphate structure, resorcinol bis(diphenyl phosphate), a sulfonated salt, halogen, phosphorous, talc, silica, a hydrated oxide, a brominated polymer, a chlorinated polymer, a phosphorated polymer, a nanoclay, an organoclay, a polyphosphonate, a poly[phosphonate-co-carbonate], a polytetrafluorethylene and styrene-acrylonitrile copolymer, a polytetrafluoroethylene and methyl methacrylate copolymer, and/or a polysiloxane copolymer.

17. The fiber tape of claim 15 or 16, wherein:
an average distance between a bottom surface of the fiber tape and a nearest one of the fibers is less than approximately 15 μm, optionally, less than approximately 10 μm; and
an average distance between a top surface of the fiber tape and a nearest one of the fibers is less than approximately 15 μm, optionally, less than approximately 10 μm.

18. The fiber tape of claim 15, wherein the fibers comprise glass fibers, carbon fibers, aramid fibers, polyethylene fibers, polyester fibers, polyamide fibers, ceramic fibers, basalt fibers, and/or steel fibers.

19. The fiber tape of claim 15, wherein the polymeric material comprises a thermoplastic polymer comprising polyethylene terephthalate, polycarbonate (PC), polybutylene terephthalate (PBT), poly(1,4-cyclohexylidene cyclohexane-1,4-dicarboxylate) (PCCD), glycol-modified polycyclohexyl terephthalate (PCTG), poly(phenylene oxide) (PPO), polypropylene (PP), polyethylene (PE), polyvinyl chloride (PVC), polystyrene (PS), polymethyl methacrylate (PMMA), polyethyleneimine or polyetherimide (PEI) or a derivative thereof, a thermoplastic elastomer (TPE), a terephthalic acid (TPA) elastomer, poly(cyclohexanedimethylene terephthalate) (PCT), polyethylene naphthalate (PEN), a polyamide (PA), polysulfone sulfonate (PSS), polyether ether ketone (PEEK), polyether ketone ketone (PEKK), acrylonitrile butyldiene styrene (ABS), polyphenylene sulfide (PPS), a copolymer thereof, or a blend thereof.

20. The fiber tape of claim 15, wherein:
the fiber tape comprises between approximately 40% and approximately 95% of the fibers by volume; and/or
the fiber tape has an average thickness that is between approximately 0.05 mm and approximately 0.30 mm.
